(19) United States
(12) Patent Application Publication
(10) Pub. No.: US 2025/0258797 A1
(43) Pub. Date: Aug. 14, 2025

(54) KADAIF, A METHOD AND DISTRIBUTED FILE FORMAT FOR EFFICIENT DATA PROCESSING AND PARALLEL ACCESS

(71) Applicant: Sami Kama, Los Altos, CA (US)

(72) Inventor: Sami Kama, Los Altos, CA (US)

(21) Appl. No.: 19/047,827

(22) Filed: Feb. 7, 2025

Related U.S. Application Data
(60) Provisional application No. 63/552,576, filed on Feb. 12, 2024.

(51) Int. Cl. G06F 16/16; G06F 16/174; G06F 16/18

(52) U.S. Cl. CPC G06F 16/164; G06F 16/1744; G06F 16/1873

(57) ABSTRACT

Data structures and data storage methods for storing data in a storage system are disclosed. The methods include reading an input data file that includes metadata and raw data, generating a hash code based on an identifier associated with the input data file, generating one or more metadata records, each metadata record including the hash code and at least a portion of the metadata, generating one or more raw data records, each raw data record including the hash code and at least a portion of the raw data, storing the generated one or more metadata records into one or more metadata files, and storing the generated one or more raw data records into one or more raw data files.

### CROSS-REFERENCE TO RELATED APPLICATIONS

This application claims the benefit of U.S. Application No. 63/552,576, filed Feb. 12, 2024, the entire disclosure of which is hereby incorporated herein by reference.

### TECHNICAL FIELD

The present invention is generally related to the field of data storage and, more specifically, to novel data structures for efficient data processing.

### BACKGROUND

Managing large volumes of metadata alongside their corresponding files presents significant challenges in modern data management systems. Existing solutions face numerous limitations in scalability, performance, and consistency, making them inadequate for managing large-scale datasets required for modern application areas, such as Artificial Intelligence (AI). In one approach, conventional file systems are enhanced with extended attributes or sidecar files for metadata storage, offering a simple approach. However, these enhance conventional file systems suffer from severe performance bottlenecks when handling large datasets. Specifically, these systems struggle with metadata search and retrieval as the number of files increases, leading to inefficiencies and delays. As the dataset grows, metadata management becomes increasingly complex and prone to inconsistencies, limiting the overall reliability and performance of the system. Additionally, the hierarchical structure of these file systems poses inherent scalability limitations, rendering them unsuitable for modern, large-scale deployments that require flexibility and speed.

Database systems, including both relational (SQL) and NoSQL solutions, have been proposed as alternatives. These systems store both files (typically as binary large objects, or BLOBs) and associated metadata in a structured format, facilitating complex queries and metadata relationships. While offering robust querying capabilities, such systems face significant drawbacks when handling large files. Storing files directly within the database introduces substantial input output (I/O) overhead, which negatively impacts performance. In many cases, the volume of the data requires distributed data bases, causing load balancing issues. Modification of metadata, such as adding new information, requires schema evolutions and processing of whole dataset. Furthermore, designing schemas for complex metadata can be a cumbersome and error-prone process. Moreover, the infrastructure and licensing costs associated with deploying database systems, particularly for large-scale applications, can be prohibitively high.

Object storage systems utilize a distributed, object-based approach to store files and metadata as key-value pairs. These systems offer horizontal scalability and provide a cost-effective solution for storing massive amounts of data. However, they face challenges in ensuring strong consistency across metadata updates in a distributed environment. The querying capabilities of object storage systems are often limited to simple key-based lookups, lacking the flexibility of relational queries that would support more complex metadata management. This limitation can hinder the ability to efficiently retrieve and analyze metadata at scale.

While existing approaches to metadata management offer various advantages, each presents distinct challenges related to scalability, performance, complexity, and cost. There remains a need for a more efficient, scalable, and cost-effective solution to handle high-performance metadata management in large-scale systems.

### SUMMARY

At least the above-discussed need is addressed and technical solutions are achieved in the art by various embodiments of the present invention. Some embodiments of the present invention address the above-discussed shortcomings of conventional data structure and metadata management methods by separating metadata information and data to different files, introducing a hash function to calculate the correlation between metadata and data locations in files, and splitting the raw data and the metadata to multiple semi-indexed files. By separating data and metadata to different files, the present invention minimizes the amount of read and write operations (I/O) needed for random access or metadata modifications. The hash function permits calculation of data location, eliminating the need for a lookup table and minimizing the need for a file scan. Separating the data to multiple files permits parallel streaming for maximal bandwidth utilization.

For example, splitting the raw data from the metadata allows efficient utilization of resources by transferring only the needed sections where they are needed, preventing duplication of whole datasets on each instance they are needed to be processed. This, in-turn, relaxes the resource requirements of processing instances, both in memory and storage. Another advantage is that since metadata volume is several orders of magnitude smaller than the raw data, all the metadata can be cached in local disks in high performance computing (HPC) optimized processing instances, while raw data can be stored in remote instances that are optimized for data storage, reducing the effective cost of processing. As a consequence of splitting and distributing the raw data to multiple files, individual instances access multiple remote raw data files simultaneously, maximizing the efficient use of the available bandwidth compared to a single stream remote access. Additionally, filtering of the data such as training opt-out requests from the copyright owners can be quickly achieved by removing the relevant entry from the metadata files, reducing time and cost to implement these and stay within regulatory boundaries. Similarly, when metadata is modified, for example when new a metadata column is added or removed, the operation is done on the metadata file set quickly, using much smaller number of bytes to be processed compared to other solutions. Some embodiments on the invention also enable a means of cheap/low-cost data versioning by keeping copies of the metadata files. Since files contain instructions on how to parse them, input-output (I/O) layer implementations can transparently operate on backward or forward compatible data formats.

Split nature of the data storage makes it easy to adapt to different infrastructure scenarios such as an on-premise datacenter HPC cluster versus a cloud based HPC cluster, transparently to the user through use of a hash function which also allows to change the resource allocations as the data set size evolves, without change in the consuming code base. The raw data can be repartitioned to a different number of files depending on the available resources with a simple file-copy like operation because of the bucket structure. Should it be desired, other hash functions can implement a load-balancing mechanism to use different replicas of the raw data files to maximize the throughput and transparent adaptive scaling of the dataset I/O layer.

The data structures described here are adaptable to any data types and volumes. For example, small, text-based raw data, such as books or web pages, can be packaged in a relatively large number records in each raw data bucket, where the data structure (the bucket) keeps offset indices on every Nth record in the bucket, while an image-based dataset can contain a comparably smaller number of records in a raw data file bucket with each record offset recorded in a bucket header. On the other end, when the raw data is very large, such as audio or video files of high fidelity and high resolution, each several Gigabytes to hundreds of Gigabytes, each raw data file can be split into multiple smaller raw data chunks and distributed to multiple files, balancing out the files and optimizing seek-like operations. The data structures and access mechanisms described here are adaptable enough to accommodate various different types datasets or any mixture of them efficiently.

Some embodiments of the present invention pertain to a processor-executed data storage method. The method comprises reading an input data file that includes metadata and raw data; generating a hash code based on an identifier associated with the input data file; generating one or more metadata records, each metadata record including the hash code and at least a portion of the metadata; generating one or more raw data records, each raw data record including the hash code and at least a portion of the raw data; storing the generated one or more metadata records into one or more metadata files; and storing the generated one or more raw data records into one or more raw data files.

In some embodiments of the present invention, the one or more metadata files each includes a header and one or more buckets. In some embodiments of the present invention, wherein the generated one or more metadata records are stored in the one or more buckets of the one or more metadata files.

In some embodiments of the present invention, the header of a respective metadata file of the one or more metadata files includes one or more of a data structure identifier, a file version, a compression flag, a compression method, a revision count, a timestamp indicating last modification, a maximum compressed bucket size, a maximum uncompressed bucket size, a compression dictionary size, a comment field, a size of the comment field, a producer tag, a size of the producer tag, a record schema, a size of the record schema, a number of buckets, offsets for the buckets, an identifier of a hash function used to generate the hash code, a size of the hash function, a reserved array, and a size of the reserved array.

In some embodiments of the present invention, each respective bucket of the one or more buckets stores one or more of a number of records in the respective bucket, a size of a compressed data buffer, a size of the compressed data buffer after decompression, one or more offsets indicating locations of each record in the respective bucket, and the data buffer.

In some embodiments of the present invention, the one or more raw data files each includes a header and one or more buckets. In some embodiments of the present invention, the generated one or more raw data records are stored in the one or more buckets of the one or more raw data files.

In some embodiments of the present invention, the header of a respective raw data file of the one or more raw data files includes one or more of a data structure identifier, a file version, a compression flag, a compression method, a revision count, a timestamp indicating last modification, a maximum compressed bucket size, a maximum uncompressed bucket size, a compression dictionary size, a comment field, a size of the comment field, a producer tag, a size of the producer tag, a record schema, a size of the record schema, a number of buckets, offsets for the buckets, an identifier of a hash function used to generate the hash code, a size of the hash function, a reserved array, and a size of the reserved array.

In some embodiments of the present invention, each respective bucket of the one or more buckets stores one or more of a number of records in the respective bucket, a size of a compressed data buffer, a size of the compressed data buffer after decompression, one or more offsets indicating locations of each record in the respective bucket, and the data buffer.

In some embodiments of the present invention, each respective metadata record of the one or more metadata records includes the hash code, a size of the identifier, a size of the portion of the metadata stored in the respective metadata record, the identifier, and the portion of the metadata stored in the respective metadata record.

In some embodiments of the present invention, each respective raw data record of the one or more raw data records includes the hash code, a size of the respective raw data record, and one or more raw data storage structures, each raw data storage structure including a size of the identifier, the identifier, a size of the portion of the raw data stored in the respective raw data storage structure, and the portion of the raw data stored in the respective raw data storage structure.

In some embodiments of the present invention, the method further comprises reading external metadata associated with the input data file and adding the external metadata to the metadata included in the input data file.

Some embodiments of the present invention pertain to a data structure for a data storage system that stores an input data file that includes metadata and raw data. The data structure comprises one or more metadata records, each metadata record including a hash code and at least a portion of the metadata, wherein the hash code is generated based on an identifier associated with the input data file; and one or more raw data records, each raw data record including the hash code and at least a portion of the raw data. The one or more metadata records are stored in one or more metadata files, and the one or more raw data records are stored in one or more raw data files.

In some embodiments of the present invention, the one or more metadata records further store external metadata associated with the input data file.

### BRIEF DESCRIPTION OF THE DRAWINGS

It is to be understood that the attached drawings are for purposes of illustrating aspects of various embodiments and may include elements that are not to scale. It is noted that like reference characters in different figures refer to the same objects.

FIG. 1 shows a computing device system, according to some embodiments of the invention.

FIG. 2 shows another computing device system, according to some embodiments of the invention.

FIG. 3 shows a schematic diagram of a data structure for split storage of metadata and data, according to some embodiments of the present invention;

FIG. 4A shows a flowchart of a method of converting and storing an input file into the split data structure of FIG. 3, according to some embodiments of the present invention;

FIG. 4B schematically illustrates the method of FIG. 4A, according to some embodiments of the present invention;

FIG. 5 shows a schematic diagram of a metadata record structure of the data structure shown in FIG. 3, according to some embodiments of the present invention;

FIG. 6 shows a schematic diagram of a RAW data record structure of the data structure shown in FIG. 3, according to some embodiments of the present invention;

FIG. 7 shows a schematic diagram of a bucket data record structure of the metadata record structure and/or the RAW record data structure, according to some embodiments of the present invention;

FIG. 8 shows a schematic diagram of a metadata file structure of the data structure shown in FIG. 3, according to some embodiments of the present invention;

FIG. 9 shows a schematic diagram of a raw data file structure of the data structure shown in FIG. 3, according to some embodiments of the present invention;

FIG. 10A shows a flowchart of a method of utilizing the split data structure of FIG. 3 in an application environment, according to some embodiments of the present invention; and

FIG. 10B schematically illustrates the method of FIG. 10A, according to some embodiments of the present invention.

### DETAILED DESCRIPTION

In some embodiments, the data structures and systems described herein provide methods for high performance metadata management in large scale systems. It should be noted that the invention is not limited to these or any other examples provided herein, which are referred to for purposes of illustration only.

In this regard, in the descriptions herein, certain specific details are set forth in order to provide a thorough understanding of various embodiments of the invention. However, one skilled in the art will understand that the invention may be practiced at a more general level without one or more of these details. In other instances, well-known structures have not been shown or described in detail to avoid unnecessarily obscuring descriptions of various embodiments of the invention.

Any reference throughout this specification to “one embodiment”, “an embodiment”, “an example embodiment”, “an illustrated embodiment”, “a particular embodiment”, and the like means that a particular feature, structure or characteristic described in connection with the embodiment is included in at least one embodiment. Thus, any appearance of the phrase “in one embodiment”, “in an embodiment”, “in an example embodiment”, “in this illustrated embodiment”, “in this particular embodiment”, or the like in this specification is not necessarily all referring to one embodiment or a same embodiment. Furthermore, the particular features, structures or characteristics of different embodiments may be combined in any suitable manner to form one or more other embodiments.

Unless otherwise explicitly noted or required by context, the word “or” is used in this disclosure in a non-exclusive sense. In addition, unless otherwise explicitly noted or required by context, the word “set” is intended to mean one or more. For example, the phrase, “a set of objects” means one or more of the objects.

In the following description, some embodiments of the present invention may be implemented at least in part by a data processing device system configured by a software program. Such a program may equivalently be implemented as multiple programs, and some or all of such software program(s) may be equivalently constructed in hardware.

Further, the phrase “at least” is or may be used herein at times merely to emphasize the possibility that other elements may exist beside those explicitly listed. However, unless otherwise explicitly noted (such as by the use of the term “only”) or required by context, non-usage herein of the phrase “at least” nonetheless includes the possibility that other elements may exist besides those explicitly listed. For example, the phrase, ‘based at least on A’ includes A as well as the possibility of one or more other additional elements besides A. In the same manner, the phrase, ‘based on A’ includes A, as well as the possibility of one or more other additional elements besides A. However, the phrase, ‘based only on A’ includes only A. Similarly, the phrase ‘configured at least to A’ includes a configuration to perform A, as well as the possibility of one or more other additional actions besides A. In the same manner, the phrase ‘configured to A’ includes a configuration to perform A, as well as the possibility of one or more other additional actions besides A. However, the phrase, ‘configured only to A’ means a configuration to perform only A.

The word “device”, the word “machine”, the word “system”, and the phrase “device system” all are intended to include one or more physical devices or sub-devices (e.g., pieces of equipment) that interact to perform one or more functions, regardless of whether such devices or sub-devices are located within a same housing or different housings. However, it may be explicitly specified according to various embodiments that a device or machine or device system resides entirely within a same housing to exclude embodiments where the respective device, machine, system, or device system resides across different housings. The word “device” may equivalently be referred to as a “device system” in some embodiments.

The phrase “derivative thereof” and the like is or may be used herein at times in the context of a derivative of data or information merely to emphasize the possibility that such data or information may be modified or subject to one or more operations. For example, if a device generates first data for display, the process of converting the generated first data into a format capable of being displayed may alter the first data. This altered form of the first data may be considered a derivative of the first data. For instance, the first data may be a one-dimensional array of numbers, but the display of the first data may be a color-coded bar chart representing the numbers in the array. For another example, if the above-mentioned first data is transmitted over a network, the process of converting the first data into a format acceptable for network transmission or understanding by a receiving device may alter the first data. As before, this altered form of the first data may be considered a derivative of the first data. For yet another example, generated first data may undergo a mathematical operation, a scaling, or a combining with other data to generate other data that may be considered derived from the first data. In this regard, it can be seen that data is commonly changing in form or being combined with other data throughout its movement through one or more data processing device systems, and any reference to information or data herein is intended to include these and like changes, regardless of whether or not the phrase “derivative thereof” or the like is used in reference to the information or data, unless otherwise required by context. As indicated above, usage of the phrase “or a derivative thereof” or the like merely emphasizes the possibility of such changes. Accordingly, the addition of or deletion of the phrase “or a derivative thereof” or the like should have no impact on the interpretation of the respective data or information. For example, the above-discussed color-coded bar chart may be considered a derivative of the respective first data or may be considered the respective first data itself.

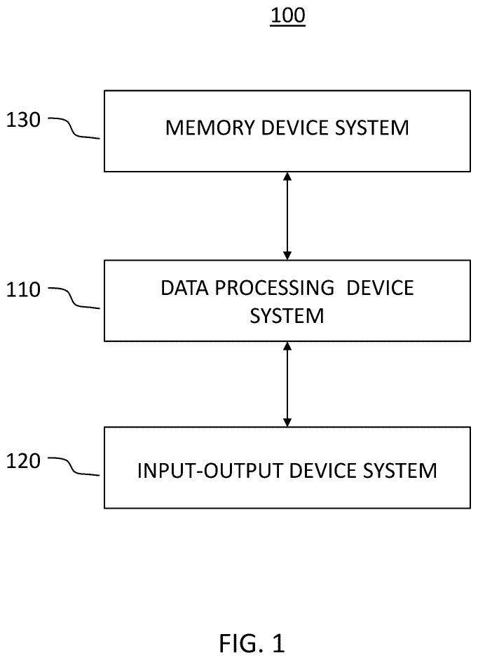

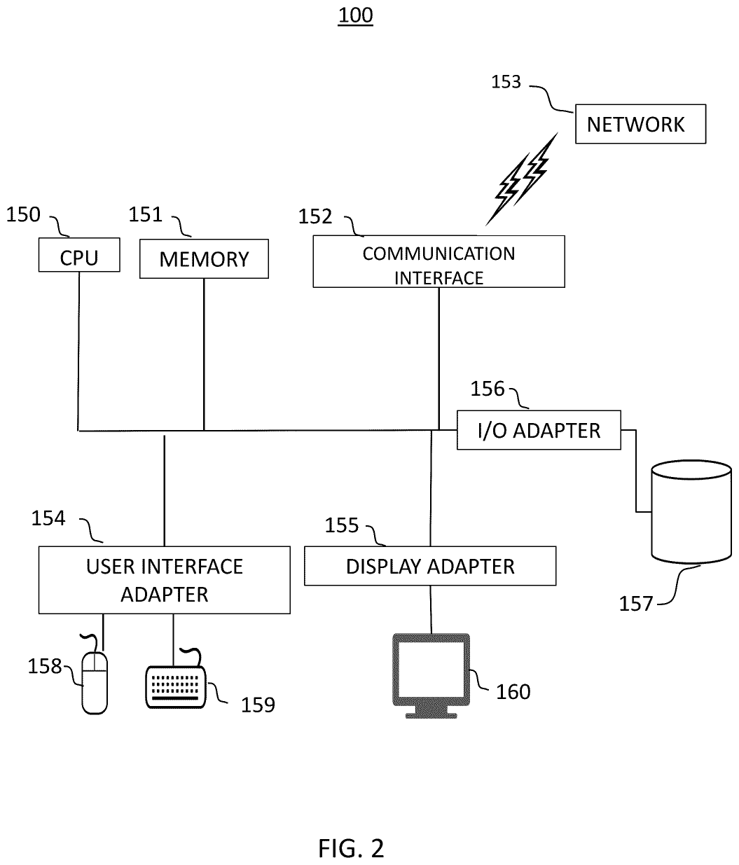

The term “program” in this disclosure should be interpreted to include one or more programs including as a set of instructions or modules that may be executed by one or more components in a system, such as a controller system or data processing device system, in order to cause the system to perform one or more operations. The set of instructions or modules may be stored by any kind of memory device, such as those described subsequently with respect to the memory device system 130, 151, or both, shown in FIGS. 1 and 2, respectively. In addition, this disclosure may describe or similarly describe that the instructions or modules of a program are configured to cause the performance of an action. The phrase “configured to” in this context is intended to include at least (a) instructions or modules that are presently in a form executable by one or more data processing devices to cause performance of the action (e.g., in the case where the instructions or modules are in a compiled and unencrypted form ready for execution), and (b) instructions or modules that are presently in a form not executable by the one or more data processing devices, but could be translated into the form executable by the one or more data processing devices to cause performance of the action (e.g., in the case where the instructions or modules are encrypted in a non-executable manner, but through performance of a decryption process, would be translated into a form ready for execution). Such descriptions should be deemed to be equivalent to describing that the instructions or modules are configured to cause the performance of the action. The word “module” may be defined as a set of instructions. The word “program” and the word “module” may each be interpreted to include multiple sub-programs or multiple sub-modules, respectively. In this regard, reference to a program or a module may be considered to refer to multiple programs or multiple modules.

Further, it is understood that information or data may be operated upon, manipulated, or converted into different forms as it moves through various devices or workflows. In this regard, unless otherwise explicitly noted or required by context, it is intended that any reference herein to information or data includes modifications to that information or data. For example, “data X” may be encrypted for transmission, and a reference to “data X” is intended to include both its encrypted and unencrypted forms, unless otherwise required or indicated by context. However, non-usage of the phrase “or a derivative thereof” or the like nonetheless includes derivatives or modifications of information or data just as usage of such a phrase does, as such a phrase, when used, is merely used for emphasis.

Further, the phrase “graphical representation” used herein is intended to include a visual representation presented via a display device system and may include computer-generated text, graphics, animations, or one or more combinations thereof, which may include one or more visual representations originally generated, at least in part, by an image-capture device.

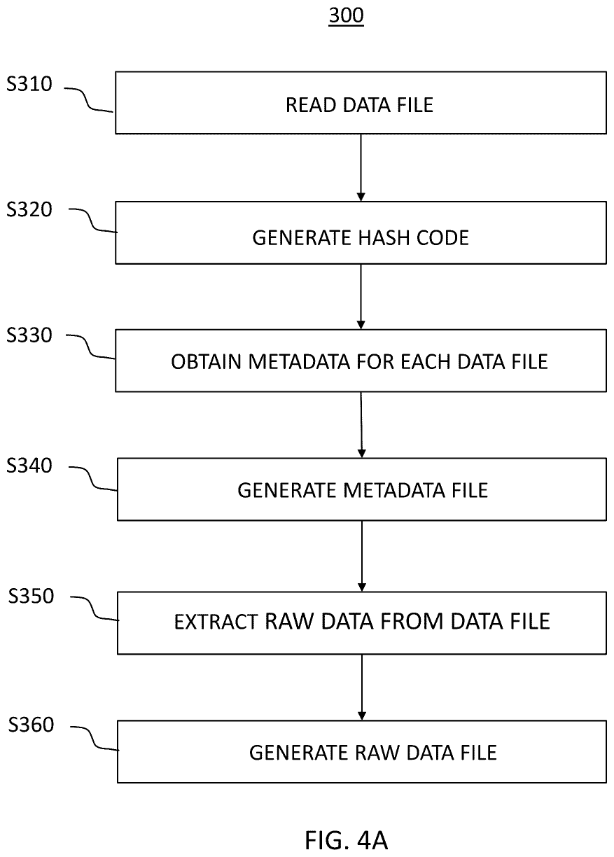

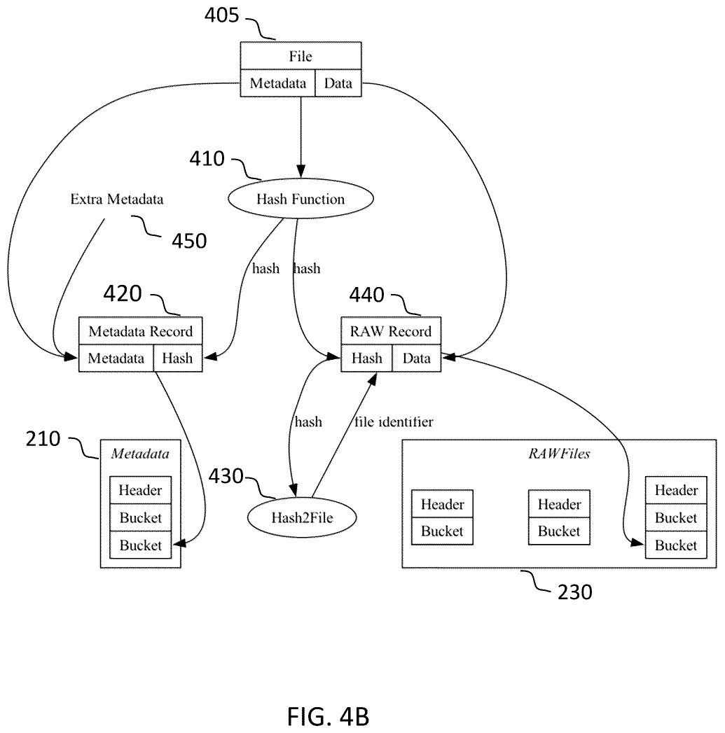

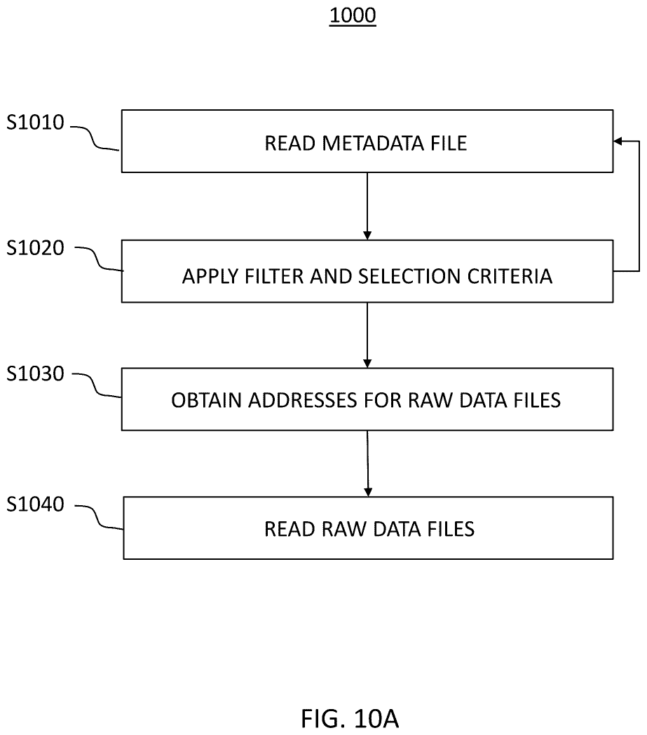

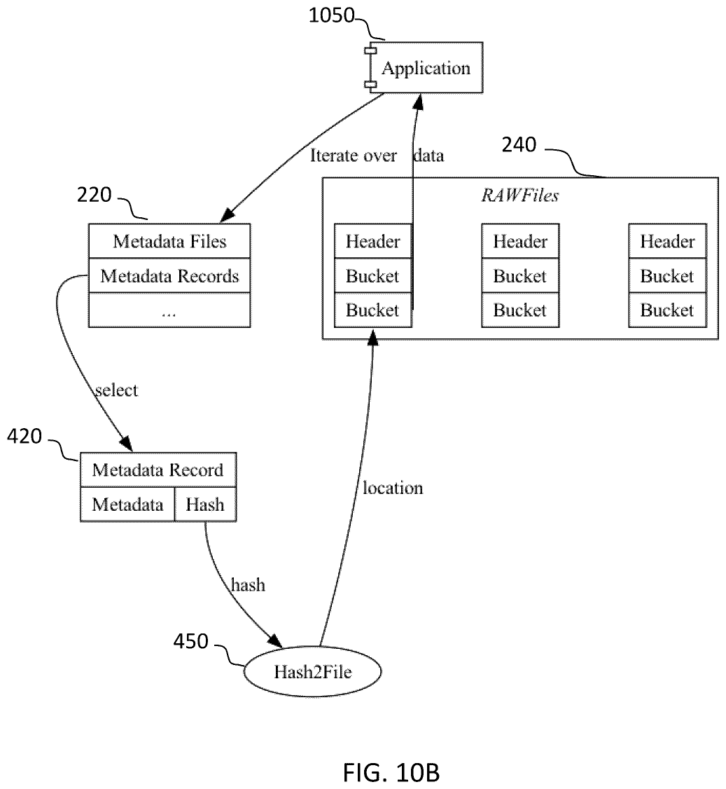

Further still, example methods are described herein with respect to FIGS. 4A, 4B, 10A, and 10B. Such figures are described to include blocks associated with computer-executable instructions. It should be noted that the respective instructions associated with any such blocks herein need not be separate instructions and may be combined with other instructions to form a combined instruction set. The same set of instructions may be associated with more than one block. In this regard, the block arrangement shown in method FIGS. 4A, 4B, 10A, and 10B herein is not limited to an actual structure of any program or set of instructions or required ordering of method tasks, and such method FIGS. 4A, 4B, 10A, and 10B, according to some embodiments, merely illustrates the tasks that instructions are configured to perform, for example upon execution by a data processing device system in conjunction with interactions with one or more other devices or device systems.

FIG. 1 schematically illustrates a system 100 according to some embodiments. In some embodiments, the system 100 may be a computing device 100 (as shown in FIG. 2). In some embodiments, the system 100 includes a data processing device system 110, an input-output device system 120, and a processor-accessible memory device system 130. The processor-accessible memory device system 130 and the input-output device system 120 are communicatively connected to the data processing device system 110.

The data processing device system 110 includes one or more data processing devices that implement or execute, in conjunction with other devices, such as one or more of those in the system 100, control programs associated with some of the various embodiments. Each of the phrases “data processing device”, “data processor”, “processor”, and “computer” is intended to include any data processing device, such as a central processing unit (“CPU”), a desktop computer, a laptop computer, a mainframe computer, a tablet computer, a personal digital assistant, a cellular phone, and any other device configured to process data, manage data, or handle data, whether implemented with electrical, magnetic, optical, biological components, or other.

The memory device system 130 includes one or more processor-accessible memory devices configured to store information, including the information needed to execute the control programs associated with some of the various embodiments. The memory device system 130 may be a distributed processor-accessible memory device system including multiple processor-accessible memory devices communicatively connected to the data processing device system 110 via a plurality of computers and/or devices. On the other hand, the memory device system 130 need not be a distributed processor-accessible memory system and, consequently, may include one or more processor-accessible memory devices located within a single data processing device.

Each of the phrases “processor-accessible memory” and “processor-accessible memory device” is intended to include any processor-accessible data storage device, whether volatile or nonvolatile, electronic, magnetic, optical, or otherwise, including but not limited to, registers, floppy disks, hard disks, Compact Discs, DVDs, flash memories, ROMs (Read-Only Memory), and RAMs (Random Access Memory). In some embodiments, each of the phrases “processor-accessible memory” and “processor-accessible memory device” is intended to include a non-transitory computer-readable storage medium. In some embodiments, the memory device system 130 can be considered a non-transitory computer-readable storage medium system.

The phrase “communicatively connected” is intended to include any type of connection, whether wired or wireless, between devices, data processors, or programs in which data may be communicated. Further, the phrase “communicatively connected” is intended to include a connection between devices or programs within a single data processor, a connection between devices or programs located in different data processors, and a connection between devices not located in data processors at all. In this regard, although the memory device system 130 is shown separately from the data processing device system 110 and the input-output device system 120, one skilled in the art will appreciate that the memory device system 130 may be located completely or partially within the data processing device system 110 or the input-output device system 120. Further in this regard, although the input-output device system 120 is shown separately from the data processing device system 110 and the memory device system 130, one skilled in the art will appreciate that such system may be located completely or partially within the data processing device system 110 or the memory device system 130, depending upon the contents of the input-output device system 120. Further still, the data processing device system 110, the input-output device system 120, and the memory device system 130 may be located entirely within the same device or housing or may be separately located, but communicatively connected, among different devices or housings. In the case where the data processing device system 110, the input-output device system 120, and the memory device system 130 are located within the same device, the system 100 of FIG. 1 can be implemented by a single application-specific integrated circuit (ASIC) in some embodiments.

The input-output device system 120 may include a mouse, a keyboard, a touch screen, another computer, or any device or combination of devices from which a desired selection, desired information, instructions, or any other data is input to the data processing device system 110. The input-output device system 120 may include any suitable interface for receiving information, instructions or any data from other devices and systems described in various ones of the embodiments.

The input-output device system 120 also may include an image generating device system, a display device system, a speaker device system, a processor-accessible memory device system, or any device or combination of devices to which information, instructions, or any other data is output from the data processing device system 110. In this regard, if the input-output device system 120 includes a processor-accessible memory device, such memory device may or may not form part or all of the memory device system 130. The input-output device system 120 may include any suitable interface for outputting information, instructions or data to other devices and systems described in various ones of the embodiments. In this regard, the input-output device system may include various other devices or systems described in various embodiments.

FIG. 2 shows an example of a computing device, which functions as system 100, according to some embodiments. The computing device 100 may include a processor 150, corresponding to the data processing device system 110 of FIG. 1, in some embodiments. The memory 151, input/output (I/O) adapter 156, and non-transitory storage medium 157 may correspond to the memory device system 130 of FIG. 1, according to some embodiments. The user interface adapter 154, mouse 158, keyboard 159, display adapter 155, and display 160 may correspond to the input-output device system 120 of FIG. 1, according to some embodiments. The computing device 100 may also include a communication interface 152 that connects to a network 153 for communicating with other computing devices 100.

Various methods 300 and 1000 may be performed by way of associated computer-executable instructions according to some example embodiments. In various example embodiments, a memory device system (e.g., memory device system 130) is communicatively connected to a data processing device system (e.g., data processing device systems 110, otherwise stated herein as “e.g., 110”) and stores a program executable by the data processing device system to cause the data processing device system to execute various embodiments of methods 300 and 1000 via interaction with at least, for example, various databases 157 shown in FIG. 2. In these various embodiments, the program may include instructions configured to perform, or cause to be performed, various ones of the instructions associated with execution of various embodiments of methods 300 and 1000. In some embodiments, methods 300 and 1000 may include a subset of the associated blocks or additional blocks than those shown in FIGS. 4A, 4B, 10A, and 10B. In some embodiments, methods 300 and 1000 may include a different sequence indicated between various ones of the associated blocks shown in FIGS. 4A, 4B, 10A, and 10B.

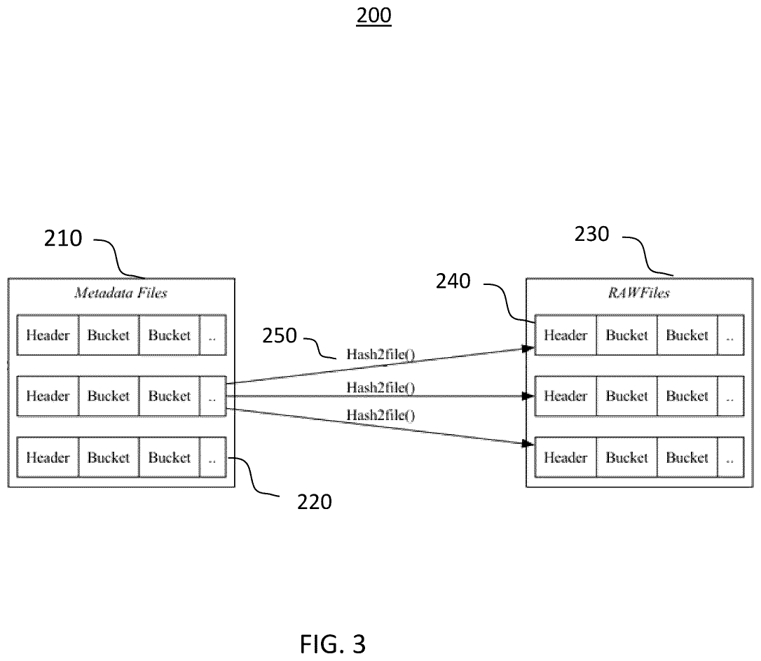

FIG. 3 illustrates a data structure 200, according to some embodiments of the present invention, for storing data in a data storage medium such as memory device 151 or storage medium 157. In some embodiments of the invention, the data storage medium may be a hard disk drive (HDD), a solid-state drive (SSD), or a non-volatile memory for physically storing data, including metadata and raw data. In some embodiments of the invention, the data storage medium is electronically connected to a controller that interacts with the storage medium to execute read and write operations based on instructions received from an external processor (such as a CPU).

In some embodiments of the invention, the storage medium employs a novel data structure 200 (also referred to as a “KADAIF” data structure) that separates the metadata 210 from the raw data 230, because the metadata 210 and the raw data 230 have different usage scenarios and patterns. The data structure 200 permits both sequential access and random access, and is efficient and highly scalable. The data structure 200 is designed to handle different kinds of data types such as text, image, video or other custom types. The bifurcated data structure organizes the metadata 210 into metadata files 220, each having a header and one or more buckets, and the raw data 230 into raw data files 240, each having a header and one or more buckets. The data structure 200 permits modification of the metadata 210, including filtering or selection operations, without accessing the raw data 230, thereby reducing data storage medium access time and associated costs. Similarly, the partitioning of the raw data 230 into raw data files 240 can be done without modification of the metadata files 220 through a hash2file function 250, allowing the dataset to be specialized for the underlying infrastructure without modifications to the user-space application. As described later in the specification, both the metadata files 220 and the raw data files 240 include a bucket structure that maximizes consecutive or parallel access by eliminating the need for exclusive access.

In some embodiments of the invention, the metadata files 220 contain information regarding the raw data 230. In some embodiments of the invention, the raw data files 240 contain the actual data content stored in the storage medium, such as files, records, or other data formats. The metadata 210 and the raw data 230 are managed separately within the storage medium, ensuring that the metadata 210 can be managed and accessed independently of the raw data 230, providing a more efficient and organized storage model.

In some embodiments of the invention, the data storage medium may include or be connected to a controller that is responsible for receiving read and write instructions from the processor, such as the CPU 150. In some embodiments, the metadata files 220 of the data structure 200 are stored in a manner that permits efficient management and manipulation of the metadata 210 independently of the raw data 230. Metadata management tasks such as updating data attributes, tracking data block locations, and maintaining data integrity are performed solely within the metadata files 220, without interfering with the raw data 230 itself. This method of metadata management reduces overhead by isolating metadata operations from the raw data access, allowing for faster updates and modifications to the metadata 210. Furthermore, because the raw data 230 can be accessed independently through hash-based parallel retrieval, metadata management does not create bottlenecks in the system.

The data structure 200 and metadata management approach are particularly advantageous in environments with high data throughput requirements, such as cloud storage systems, large-scale databases, and real-time data analytics. By enabling parallel access to the raw data 230 and isolating metadata management, the data structure 200 can deliver improved performance, scalability, and flexibility for diverse applications.

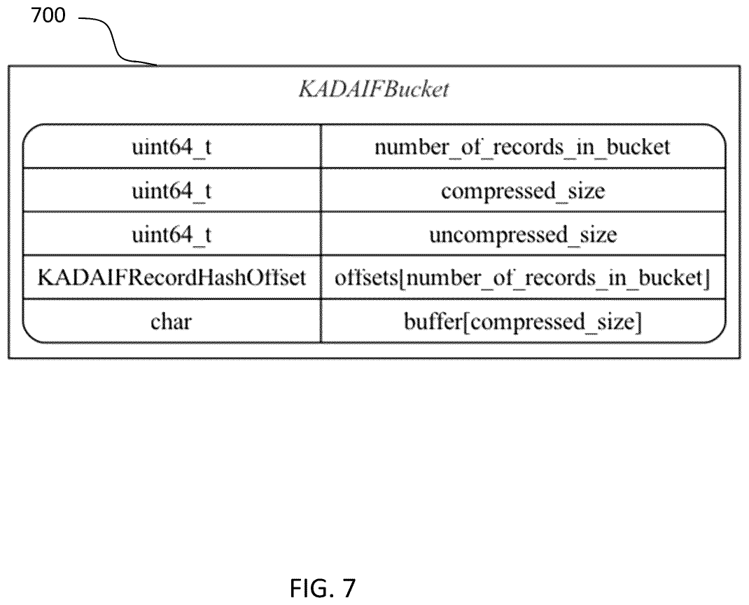

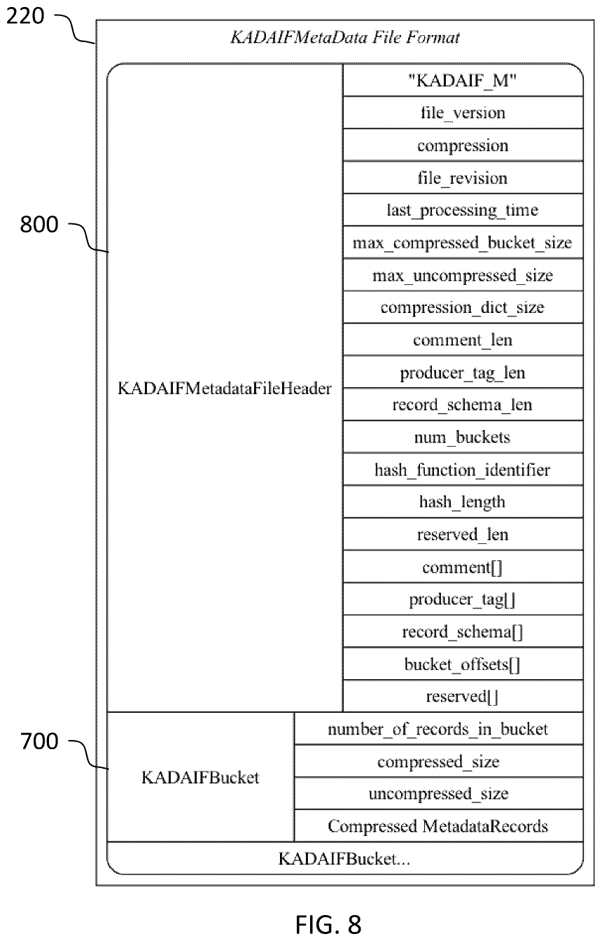

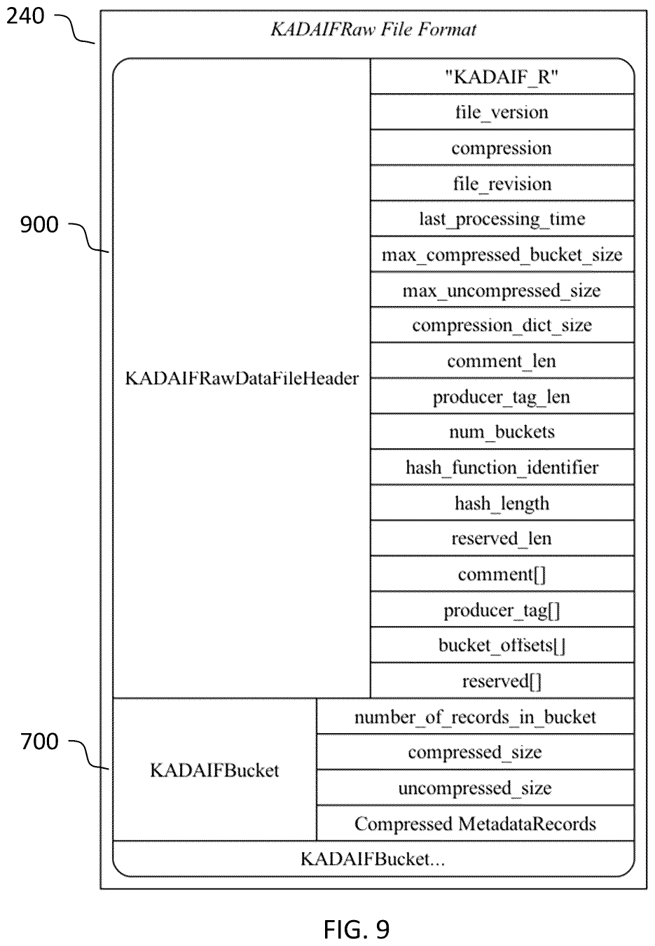

FIG. 4A shows a flowchart for a method 300 of mapping the data to be stored in the data storage medium into the data structure 200, according to some embodiments of the invention. The mapping steps are also schematically illustrated in FIG. 4B. In step S310, the input data file 405 is accessed/read. In step S320, a hash function 310 is used to generate a hash code from a unique identifier, such as a filename or a URL, of the input data file 405. In step S330, the metadata 210 in the input data file 405 is extracted and tagged with the hash code generated in step S320 to generate one or more metadata records 420. In some embodiments, other metadata 450, obtained from external sources and not part of the input data file 405, may be added as part of the generated metadata records 420. In step S340, the metadata file 220 is generated by adding a header and storing each of the generated one or more metadata records 420 as a bucket of the metadata file 220. Details of the data structure for the bucket and the header for the metadata file 220 are described later in this specification with reference to FIGS. 7 and 8. In step S350, the raw data 230 in the input data file 405 is extracted and tagged with the hash code generated in step S320 to generate one or more raw data records 440. In step S360, the raw data file 240 is generated by adding a header and storing each of the generated one or more raw data records 440 as a bucket of the raw data file 240. Details of the data structure for the bucket and the header for the raw data file 240 are described later in this specification with reference to FIGS. 7 and 9.

FIG. 4B illustrates the process of organizing and storing the data file 405 into the data structure 200. The data file 405 includes metadata 210 and raw data 230. A hash function 410 generates a hash code based on a unique identifier associated with the data file 405. The metadata 210 is separated from the raw data 230, and associated with the generated hash code to generate the metadata records 420. Additional metadata 450, external to the data file 405 but associated with the data file 405, may also be combined with the metadata 210 and stored in the metadata records 420. Each of the metadata records 420 are stored in a bucket in the metadata file 220 associated with the data file 405. The hash code generated by the hash function 410 is further passed through a hash2file function 430 to generate a file identifier that identifies the location (address) where the raw data is stored in the storage medium. The hash code and the raw data are used to generate the raw data records 440. The raw data records 440 are stored as buckets in the raw data file 240.

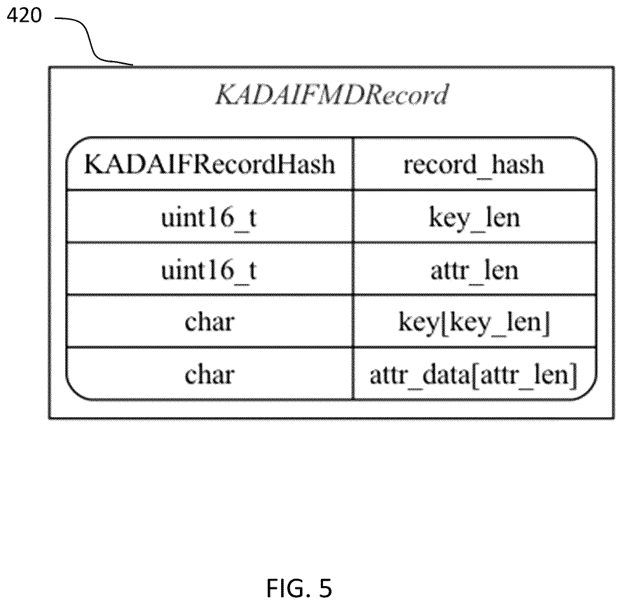

FIG. 5 illustrates the structure of a metadata record 420, according to some embodiments of the invention. It should be noted that the enumerated fields in the data structure of the metadata record 420 are for reference only and may be changed, shortened, or expanded. For purposes of illustration only, and as a non-limiting example, in some embodiments of the invention, the metadata record 420 includes the hash code (record_hash) that is generated by the hash function 410. The hash code is followed by two fields with integer values (key_len and attr_len), representing the length of the unique identifier of the file, and length of the metadata. These integer value fields are followed by a first data block (key[key_len]) of key_len bytes containing the unique identifier of the file and a second data block (attr_data[attr_len]) of attr_len bytes containing the metadata.

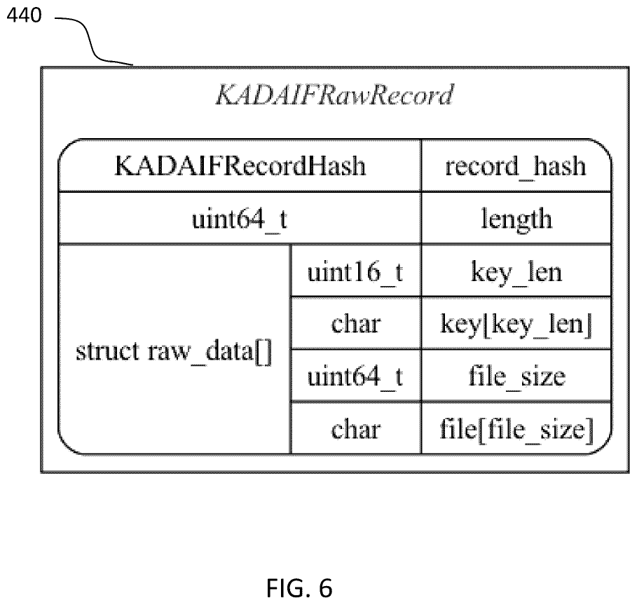

FIG. 6 illustrates the structure of a raw data record 440, according to some embodiments of the invention. It should be noted that the enumerated fields in the data structure of the raw data record 440 are for reference only and may be changed, shortened, or expanded. For purposes of illustration only, and as a non-limiting example, in some embodiments of the invention, the raw data record 440 includes the hash code (record_hash) that is generated by the hash function 410. The hash code is followed by an integer value field (length) that defines the total number of bytes occupied by the raw data record 440, including the hash code. The raw data record 440 includes one or more raw data structures (struct raw_data[]). Each raw data structure starts with a first integer value field (key_len) representing the length of the unique key of the file followed by a first data block (key[key_len]) of key_len bytes containing the unique key of the file. A second integer value field (file_size) is followed by a second data block (file[file_size]) of file_size bytes, representing the data of the file. Each raw data record 440 can contain one or more raw data structures to address data versioning and hash collisions, i.e. different unique identifiers leading to same hash value.

FIG. 7 illustrates the structure of a bucket 700 of a metadata file 220 or a raw data file 240, according to some embodiments of the invention. It should be noted that the enumerated fields in the data structure of the bucket 700 are for reference only and may be changed, shortened, or expanded. For purposes of illustration only, and as a non-limiting example, in some embodiments of the invention, the bucket 700 may start with an integer value field listing the number of records stored in the bucket, followed by another integer value field defining the size of a data buffer and, if it is optionally compressed, a third integer value field defining how much storage is needed when the buffer is uncompressed. The bucket 700 may also include an optional list of hash codes and offset pairs, indicating the location of each record in the bucket. The data structure for the bucket 700 permits the offset list to contain entries for every record or every nth record based on the data properties or performance requirements. The list of offsets is followed by concatenated metadata records 420 or raw data records 440 for the metadata file 220 or the raw data file 240 respectively.

FIG. 8 illustrates the structure of the metadata file 220, according to some embodiments of the invention. Every metadata file 220 contains a header section 800 followed by one or more buckets 700. It should be noted that the enumerated fields in the data structure of the metadata file 220 are for reference only and may be changed, shortened, or expanded. For purposes of illustration only, and as a non-limiting example, in some embodiments of the invention, the metadata file header 800 includes a marker field having a fixed byte string with a data structure identifier that identifies the type of data structure. As a non-limiting example, the string is an 8-byte string with the contents “KADAIF_M” in ASCII format, identifying the metadata file 220 as a KADAIF metadata file. In some embodiments of the invention, this string is not null terminated. In some embodiments of the invention, the header 800 includes a first integer field (file_version) indicating the file format version. The value of the file_version field indicates the file structure version to enable backward compatibility and is also used in file decoding in an application layer. In some embodiments of the invention, the header 800 includes a second integer field (compression) indicating whether data compression is employed and if so, which compression method is used to compress the contents of the buckets. The header 800 may also include a third integer field (file_revision) to keep track of how many times the file has been modified since its initial creation, and is incremented at every file modification. A fourth integer field (last_processing_time) contains the timestamp of last file modification operation. These two fields are used by users of the input file 405 to ensure the reproducibility of the results based on these files at a later time. The header 800 may include integer value fields such as max_compressed_bucket_size, max_uncompressed_size and compression_dict_size correspond to size of the largest bucket after compression, size of largest bucket before compression, and size of the compression dictionary if a compression algorithm is used and needs a compression dictionary stored separately, respectively. The header 800 may also include integer value fields such as comment_len, producer_tag_len, and record_schema_len defining the number of bytes occupied by comment, producer_tag, and record_schema fields. A num_buckets field stores the total number of buckets in the metadata file 220 as well as the number of entries in the bucket_offsets array. The hash_function_identifier and hash_length fields store the encoding for the hash function 410 and the length of each hash value in bytes. The header 800 may also include an integer value field reserved_len defining the length of a reserved array at the end of the header. The reserved_len and reserved array fields provide a mechanism for forward-compatibility by allowing a means for applications to ignore extensions appended to the header at a later version of the file format. In some embodiments of the invention, an application that produces a metadata file with an evolved schema containing more information can set the reserved_len field to the number of bytes used by the extension while permitting another application that is based on an earlier schema to disregard the extra information and still be able to process the metadata file.

The comment field, who size in bytes is defined by the comment_len field, is used for embedding human readable notes into the metadata file 220 to describe the file contents and purpose. The producer_tag field uses the number of bytes stored in the producer_tag_len field to store a unique identifier, such as a software revision tag, for the producer of the file. In some embodiments of the invention, the producer_tag field is used for validation and bug fixing purposes. The schema describing the contents of the records in the metadata file 220 is stored in the record_schema field, which is record_schema_len bytes long. This schema is used for both validating the file contents and creating record parsers dynamically during the file processing. If the structure of the metadata records is modified, such as by adding new metadata fields or removing existing fields, the record_schema field is also updated to reflect this change. The bucket_offsets array contains num_buckets integers representing the number of bytes between the beginning of the metadata file 220 and the first byte of each respective bucket 700 in the metadata file 220. In some embodiments of the invention, the header 800 includes the reserved field that is reserved_len bytes long, which is described above and is used to store information that is not interpreted by the I/O layer and can be modified to contain extra information that is application specific. The header is followed by one or more buckets as specified in the num_buckets field.

FIG. 9 illustrates the structure of the raw data file 240, according to some embodiments of the invention. Every raw data file 240 contains a header section 900 followed by one or more buckets 700. It should be noted that the enumerated fields in the data structure of the raw data file 240 are for reference only and may be changed, shortened, or expanded. For purposes of illustration only, and as a non-limiting example, in some embodiments of the invention, the raw data file header 900 includes a marker field having a fixed byte string with a data structure identifier that identifies the type of data structure. As a non-limiting example, the string is an 8-byte string with the contents “KADAIF_R” in ASCII format, identifying the raw data file 240 as a KADAIF raw data file. In some embodiments of the invention, this string is not null terminated. In some embodiments of the invention, the header 900 in the raw data file 240 includes similar fields as the header 800 in the metadata file 220, shown in FIG. 8. The header 900 is followed by one or more buckets 700 containing the raw data 230. In some embodiments of the invention, the notable differences between metadata file header 800 and raw data file header 900 are strings stored in the marker field and the absence of the record_schema_len and record_schema fields in the raw data file 240.

FIG. 10A shows a flowchart for a method 1000 of utilizing the metadata files 220 and the raw data files 240 after generation, according to some embodiments of the invention. The file utilization steps are also schematically illustrated in FIG. 10B. In steps S1010 and S1020, an application 1050 iteratively reads one or more metadata files 220 associated with target raw data required by the application 1050 (step S1010). The application 1050 may also apply filtering and selection criteria to the metadata records 420 stored in the metadata files 220 (steps S1020) to identify relevant metadata records. In step S1030, the value stored in the record_hash field of the relevant metadata records 420 is passed through the hash2file function 430 to determine the locations (addresses) of the associated raw data 230 in the storage. In step S1040, the application 1050 uses the determined locations of the raw data files 240 to read the relevant raw data 230. Since the raw data 230 is distributed across multiple raw data files 240, the likelihood of raw data records 440 for two consecutively selected metadata records 420 to be located in the same file is reduced. Thus, the application 1050 can read data in parallel from multiple raw data files 240 simultaneously, increasing throughput and working around the inefficiencies of single file I/O (input/output).

FIG. 10B schematically illustrates the process of utilizing the metadata files 220 and the raw data files 240 after generation. The application 1050 reads metadata files 220 to identify metadata records 420 that match defined search and filtering criteria. The hash values recorded in the selected metadata records are passed through the hash2file function 430 to identify raw data buckets 700 (of raw data records 440 stored in raw data files 240) that contain the raw data to be read.

Subsets or combinations of various embodiments described above provide further embodiments.

These and other changes can be made to the invention in light of the above-detailed description and still fall within the scope of the present invention. In general, in the following claims, the terms used should not be construed to limit the invention to the specific embodiments disclosed in the specification. Accordingly, the invention is not limited by the disclosure, but instead its scope is to be determined entirely by the following claims.

What is claimed is:

1. A processor-executed data storage method, comprising:
reading an input data file that includes metadata and raw data;
generating a hash code based on an identifier associated with the input data file;
generating one or more metadata records, each metadata record including the hash code and at least a portion of the metadata;
generating one or more raw data records, each raw data record including the hash code and at least a portion of the raw data;
storing the generated one or more metadata records into one or more metadata files; and
storing the generated one or more raw data records into one or more raw data files.

2. The data storage method according to claim 1,
wherein the one or more metadata files each includes a header and one or more buckets, and
wherein the generated one or more metadata records are stored in the one or more buckets of the one or more metadata files.

3. The data storage method according to claim 2, wherein the header of a respective metadata file of the one or more metadata files includes one or more of a data structure identifier, a file version, a compression flag, a compression method, a revision count, a timestamp indicating last modification, a maximum compressed bucket size, a maximum uncompressed bucket size, a compression dictionary size, a comment field, a size of the comment field, a producer tag, a size of the producer tag, a record schema, a size of the record schema, a number of buckets, offsets for the buckets, an identifier of a hash function used to generate the hash code, a size of the hash function, a reserved array, and a size of the reserved array.

4. The data storage method according to claim 2, wherein each respective bucket of the one or more buckets stores one or more of a number of records in the respective bucket, a size of a compressed data buffer, a size of the compressed data buffer after decompression, one or more offsets indicating locations of each record in the respective bucket, and the data buffer.

5. The data storage method according to claim 1,
wherein the one or more raw data files each includes a header and one or more buckets, and
wherein the generated one or more raw data records are stored in the one or more buckets of the one or more raw data files.

6. The data storage method according to claim 5, wherein the header of a respective raw data file of the one or more raw data files includes one or more of a data structure identifier, a file version, a compression flag, a compression method, a revision count, a timestamp indicating last modification, a maximum compressed bucket size, a maximum uncompressed bucket size, a compression dictionary size, a comment field, a size of the comment field, a producer tag, a size of the producer tag, a record schema, a size of the record schema, a number of buckets, offsets for the buckets, an identifier of a hash function used to generate the hash code, a size of the hash function, a reserved array, and a size of the reserved array.

7. The data storage method according to claim 5, wherein each respective bucket of the one or more buckets stores one or more of a number of records in the respective bucket, a size of a compressed data buffer, a size of the compressed data buffer after decompression, one or more offsets indicating locations of each record in the respective bucket, and the data buffer.

8. The data storage method according to claim 1, wherein each respective metadata record of the one or more metadata records includes the hash code, a size of the identifier, a size of the portion of the metadata stored in the respective metadata record, the identifier, and the portion of the metadata stored in the respective metadata record.

9. The data storage method according to claim 1, wherein each respective raw data record of the one or more raw data records includes the hash code, a size of the respective raw data record, and one or more raw data storage structures, each raw data storage structure including a size of the identifier, the identifier, a size of the portion of the raw data stored in the respective raw data storage structure, and the portion of the raw data stored in the respective raw data storage structure.

10. The data storage method according to claim 1, further comprising reading external metadata associated with the input data file and adding the external metadata to the metadata included in the input data file.

11. A data structure for a data storage system that stores an input data file that includes metadata and raw data, comprising:
one or more metadata records, each metadata record including a hash code and at least a portion of the metadata, wherein the hash code is generated based on an identifier associated with the input data file; and
one or more raw data records, each raw data record including the hash code and at least a portion of the raw data,
wherein the one or more metadata records are stored in one or more metadata files, and
wherein the one or more raw data records are stored in one or more raw data files.

12. The data structure according to claim 11,
wherein the one or more metadata files each includes a header and one or more buckets, and
wherein the one or more metadata records are stored in the one or more buckets of the one or more metadata files.

13. The data structure according to claim 12, wherein the header of a respective metadata file of the one or more metadata files includes one or more of a data structure identifier, a file version, a compression flag, a compression method, a revision count, a timestamp indicating last modification, a maximum compressed bucket size, a maximum uncompressed bucket size, a compression dictionary size, a comment field, a size of the comment field, a producer tag, a size of the producer tag, a record schema, a size of the record schema, a number of buckets, offsets for the buckets, an identifier of a hash function used to generate the hash code, a size of the hash function, a reserved array, and a size of the reserved array.

14. The data structure according to claim 12, wherein each respective bucket of the one or more buckets stores one or more of a number of records in the respective bucket, a size of a compressed data buffer, a size of the compressed data buffer after decompression, one or more offsets indicating locations of each record in the respective bucket, and the data buffer.

15. The data structure according to claim 11,
wherein the one or more raw data files each includes a header and one or more buckets, and
wherein the generated one or more raw data records are stored in the one or more buckets of the one or more raw data files.

16. The data structure according to claim 15, wherein the header of a respective raw data file of the one or more raw data files includes one or more of a data structure identifier, a file version, a compression flag, a compression method, a revision count, a timestamp indicating last modification, a maximum compressed bucket size, a maximum uncompressed bucket size, a compression dictionary size, a comment field, a size of the comment field, a producer tag, a size of the producer tag, a record schema, a size of the record schema, a number of buckets, offsets for the buckets, an identifier of a hash function used to generate the hash code, a size of the hash function, a reserved array, and a size of the reserved array.

17. The data structure according to claim 15, wherein each respective bucket of the one or more buckets stores one or more of a number of records in the respective bucket, a size of a compressed data buffer, a size of the compressed data buffer after decompression, one or more offsets indicating locations of each record in the respective bucket, and the data buffer.

18. The data structure according to claim 11, wherein each respective metadata record of the one or more metadata records includes the hash code, a size of the identifier, a size of the portion of the metadata stored in the respective metadata record, the identifier, and the portion of the metadata stored in the respective metadata record.

19. The data structure according to claim 11, wherein each respective raw data record of the one or more raw data records includes the hash code, a size of the respective raw data record, and one or more raw data storage structures, each raw data storage structure including a size of the identifier, the identifier, a size of the portion of the raw data stored in the respective raw data storage structure, and the portion of the raw data stored in the respective raw data storage structure.

20. The data structure according to claim 11, wherein the one or more metadata records further store external metadata associated with the input data file.
